(19) United States
(12) Patent Application Publication
(10) Pub. No.: US 2024/0039078 A1
(43) Pub. Date: Feb. 1, 2024

(54) HEAT DISSIPATING BATTERY PACK

(71) Applicant: Apple Inc., Cupertino, CA (US)

(72) Inventors: Christopher R. Pasma, Cupertino, CA (US); Angelo V. Marasco, Cupertino, CA (US); Brian K. Shiu, Cupertino, CA (US); Abhishek P. Shiwalkar, Cupertino, CA (US)

(21) Appl. No.: 18/362,750

(22) Filed: Jul. 31, 2023

Related U.S. Application Data
(60) Provisional application No. 63/394,043, filed on Aug. 1, 2022.

(51) Int. Cl. H01M 10/6551; H01M 50/103; H01M 50/119; H01M 50/124; H01M 50/131; H01M 10/653; H01M 50/128; H01M 50/247; H01M 50/202

(52) U.S. Cl. CPC H01M 10/6551; H01M 50/103; H01M 50/119; H01M 50/1245; H01M 50/131; H01M 10/653; H01M 50/128; H01M 50/247; H01M 50/202; H01M 2220/30

(57) ABSTRACT

Aspects of the disclosure involve various battery packs. In general, the battery pack includes a battery cell and an enclosure. The enclosure includes a first portion and a plurality of walls that extend perpendicularly from the first portion. The enclosure includes a second portion connected to the plurality of walls to form a body enclosing the battery cell. The first portion, the second portion, and the plurality of walls are a first material comprising stainless steel. The enclosure includes a layer of a second material covering at least a portion of at least one of the first portion, the second portion, and one of the plurality of walls. The second material comprises aluminum, an aluminum alloy, copper, a copper alloy, graphite, graphene, or a combination thereof and has a greater thermal conductivity than the first material.

### PRIORITY

This patent application claims the benefit under 35 U.S.C. § 119(e) of U.S. Patent Application No. 63/394,043, entitled “Heat Dissipating Battery Pack,” filed on Aug. 1, 2022, the contents of which are incorporated herein by reference in its entirety.

### TECHNICAL FIELD

This disclosure relates generally to battery systems, and more specifically to battery packs.

### BACKGROUND

A portable electronic device may malfunction if it one or more of its components reaches too high of a temperature or too low of a temperature. Some portable electronic devices use temperature-based control loops to prevent such malfunctioning. However, such temperature-based control loops do not allow the battery pack to participate in the overall thermal management of the device. It is with these and other issues in mind that various aspects of the disclosure were developed.

### SUMMARY

In one aspect, the disclosure is directed to a battery pack that contributes to the overall thermal management of the system or device in which it is utilized. In general, the battery pack may include a battery cell and an enclosure. The enclosure may include a first portion and a plurality of walls that extend perpendicularly from the first portion. The enclosure may include a second portion connected to the plurality of walls to form a body enclosing the battery cell. The first portion, the second portion, and the plurality of walls may be a first material comprising stainless steel. The enclosure may include a layer of a second material covering at least a portion of at least one of the first portion, the second portion, and one of the plurality of walls. The second material may comprise aluminum, an aluminum alloy, copper, a copper alloy, graphite, graphene, or a combination thereof and may have a greater thermal conductivity than the first material.

In a further aspect, the disclosure is directed to a portable electronic device that includes a set of components powered by a battery pack that contributes to the overall thermal management of the device. In general, the portable electronic device may include the battery pack and a device enclosure enclosing the battery pack. The battery pack may include a battery cell and an enclosure. The enclosure may include a first portion and a plurality of walls that extend perpendicularly from the first portion. The enclosure may include a second portion connected to the plurality of walls to form a body enclosing the battery cell. The first portion, the second portion, and the plurality of walls may be a first material comprising stainless steel. The enclosure may include a layer of a second material covering at least a portion of at least one of the first portion, the second portion, and one of the plurality of walls. The second material may comprise aluminum, an aluminum alloy, copper, a copper alloy, graphite, graphene, or a combination thereof and may have a greater thermal conductivity than the first material.

In a further aspect, the disclosure is directed to a battery enclosure that contributes to the overall thermal management of the system or device in which it is utilized. In general, the battery enclosure includes a first portion and a plurality of walls that extend perpendicularly from the first portion. The enclosure may include a second portion connected to the plurality of walls to form a body enclosing a battery cell. The first portion, the second portion, and the plurality of walls may be a first material comprising stainless steel. The enclosure may include a layer of a second material covering at least a portion of at least one of the first portion, the second portion, and one of the plurality of walls. The second material may comprise aluminum, an aluminum alloy, copper, a copper alloy, graphite, graphene, or a combination thereof and may have a greater thermal conductivity than the first material.

### BRIEF DESCRIPTION OF THE DRAWINGS

Although the following figures and description illustrate specific embodiments and examples, the skilled artisan will appreciate that various changes and modifications may be made without departing from the spirit and scope of the disclosure.

FIG. 1A is a top view of a battery pack and a heat generating component, according to an illustrative embodiment;

FIG. 1B is a top view of a battery pack and a heat generating component, according to an illustrative embodiment;

FIG. 1C is a top view of a battery pack and a plurality of heat generating components, according to an illustrative embodiment;

FIG. 1D is a top view of a battery pack and a plurality of heat generating components, according to an illustrative embodiment;

FIG. 2A is a top view of a battery pack including a plurality of additional portions extending from the enclosure, according to an illustrative embodiment;

FIG. 2B is a top view of a battery pack including an additional portion extending from the enclosure, according to an illustrative embodiment;

FIG. 3 is a cross-sectional view of a battery pack, according to an illustrative embodiment;

FIG. 4 is a cross-sectional view of a battery pack, according to an illustrative embodiment;

FIG. 5 is a portable electronic device, according to an illustrative embodiment; and

FIG. 6 illustrates an example method for manufacturing a battery pack, according to an illustrative embodiment.

### DETAILED DESCRIPTION

As noted above, aspects of the disclosure involve a battery pack that contributes to the overall thermal management of the system or device in which it is utilized. In general, the battery pack may include a battery cell and an enclosure. The enclosure may include a first portion and a plurality of walls that extend perpendicularly from the first portion. The enclosure may include a second portion connected to the plurality of walls to form a body enclosing the battery cell. The first portion, the second portion, and the plurality of walls may be a first material comprising stainless steel. The enclosure may include a layer of a second material covering at least a portion of at least one of the first portion, the second portion, and one of the plurality of walls. The second material may comprise aluminum, an aluminum alloy, copper, a copper alloy, graphite, graphene, or a combination thereof and may have a greater thermal conductivity than the first material.

By “perpendicular” or “perpendicularly” as used herein, it is meant that one object (e.g. portion, wall, or plurality of walls) is at a 900+/−100 angle relative to a second object. In some variations, one object may be at a 90+/−7° angle relative to a second object. In some variations, one object may be at a 90+/−5° angle relative to a second object. In some variations, one object may be at a 90+/−3° angle relative to a second object. In some variations, one object may be at a 900+/−10 angle relative to a second object.

By “parallel” as used herein, it is meant that one object (e.g. portion, wall, or plurality of walls) is at a 0°+/−100 angle relative to a second object. In some variations, one object may be at a 0°+/−7° angle relative to a second object. In some variations, one object may be at a 0°+/−5° angle relative to a second object. In some variations, one object may be at a 0°+/−3° angle relative to a second object. In some variations, one object may be at a 0°+/−10 angle relative to a second object.

Through this particular battery pack design, several advantages may be obtained over conventional battery packs. For example, battery packs may be utilized to power one or more components in a variety of different systems and devices. Such components, including but not limited to processors, radios, system on chip (SoC), or any other component that may be powered by a battery pack, may generate heat. However, such components may malfunction if they exceed a certain temperature (e.g., overheat). For example, the computing ability of such components may be adversely affected if they overheat. Portable electronic devices utilizing conventional battery packs may include thermally conductive material external to the battery pack (e.g., a temperature-based control loop along a display of the device or otherwise outside of an enclosure of the battery pack). The thermally conductive material external to the battery pack may be configured to dissipate the heat generated by the heat-generating components. However, as the conventional battery packs themselves do not include thermally conductive material configured to dissipate such heat, conventional battery packs are unable to play a role in the overall thermal management of the device.

The layer of the second material included in the improved battery pack described herein may be configured to capture and diffuse heat, such as heat generated by components being powered by the battery pack, across a length of the layer of the second material. Thus, the layer of the second material creates a new thermal pathway (e.g., heat-sink, heat-pipe, etc.) inside the device between the heat-generating components and the battery cell via the enclosure. The addition of this new thermal pathway may change the thermal response inside of the device during battery discharging and charging. Such a change in thermal response may provide a beneficial power envelope for the heat-generating components of the device while maximum temperature limits may still be adhered to by the temperature-based control loop.

Additionally, if the temperature of a battery cell included in a battery pack is below a certain threshold (e.g., is too cold), the battery cell may be limited on how fast it is able to charge. As conventional battery packs are not able to capture the heat generated by the above-described heat-generating components, conventional battery packs are not able to use such heat to warm up the battery cell. As a result, the battery cells in conventional battery packs may take a long time to charge when exposed to low temperatures.

As noted above, the layer of the second material included in the improved battery pack described herein may be configured to capture and diffuse heat across a length of the layer of the second material. The heat captured by the layer of the second material may be utilized to warm up the battery cell if the temperature of the battery cell is below a certain threshold. As a result, when exposed to low temperatures, the battery cell may be able to charge quicker than the battery cells found in conventional battery packs.

Additional features of the battery pack may also be considered and/or included to improve the battery pack's ability to contribute to the overall thermal management of the system or device in which it is utilized. For example, in some embodiments, the layer of the second material is connected to the first portion, the second portion, or one of the plurality of walls via at least one of an adhesive, a weld, or a clad.

In some embodiments, the enclosure includes a layer of the first material covering the layer of the second material. The first material may be corrosion resistant. By covering the layer of the second material with a layer of the first material, the layer of the second material may be protected against corrosion by factors external to the battery pack.

In some embodiments, the battery cell may include a set of layers immersed in an electrolyte. The first material may be resistant to corrosion by the electrolyte. The second material may corrode or have a negative reaction if exposed to the electrolyte. The first material that is positioned in between the battery cell and the layer of the second material may protect the layer of the second material against corrosion by the electrolyte.

In some embodiments, the enclosure includes at least one additional portion that extends from the first portion or the second portion in a direction parallel to the first portion or the second portion. The at least one additional portion may be configured to capture heat generated by at least one source external to the battery pack (e.g., generated by one or more heat-generating components). The at least one additional portion may provide the battery pack with better coupling to the source(s) responsible for generating the heat. After the at least one additional portion captures the heat, the layer of the second material may be configured to capture the heat from the at least one additional portion and diffuse the heat across a length of the layer of the second material.

In some embodiments, the battery pack may have any shape or size, giving the battery assembly substantial form factor flexibility. For example, the battery pack may be formed to fit within a prescribed area within a device, such as a portable electronic device. This form may include any number of sides, angles, and/or shapes to account for one or more other components within the computing device casing. However, any shape or size of the battery pack is contemplated. The battery pack may include any number of faces and/or angles.

The various designs and methods disclosed herein provide for battery packs for any type of electrical device. It will be appreciated that, although some of the example implementations described herein involve the battery pack providing power to a type of electrical device, such as a portable electronic device, the battery pack designs and methods described herein may apply to any type of electrical device, computing system or mobile device where power from a battery pack may be desired to power the device. Further, any type of lithium-ion cell may be used with the embodiments and designs of the battery pack described herein.

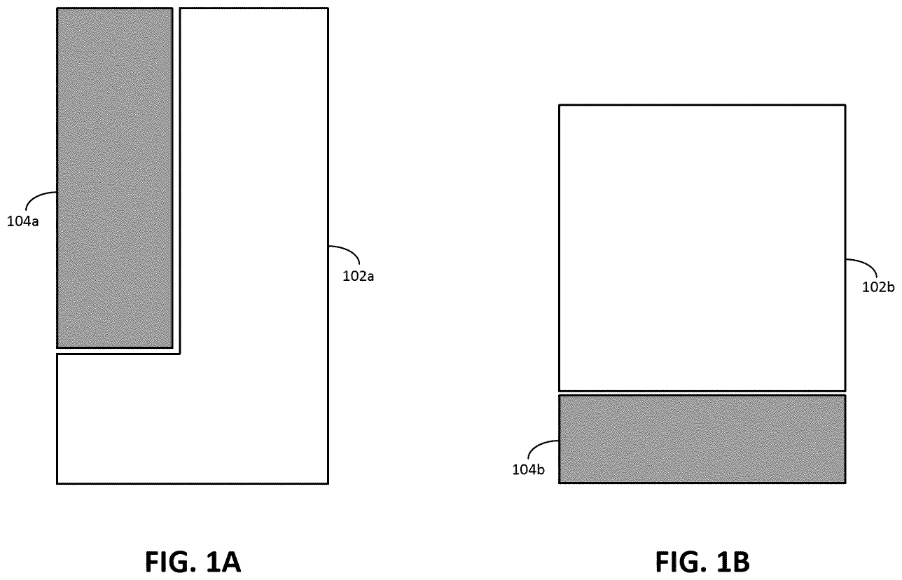

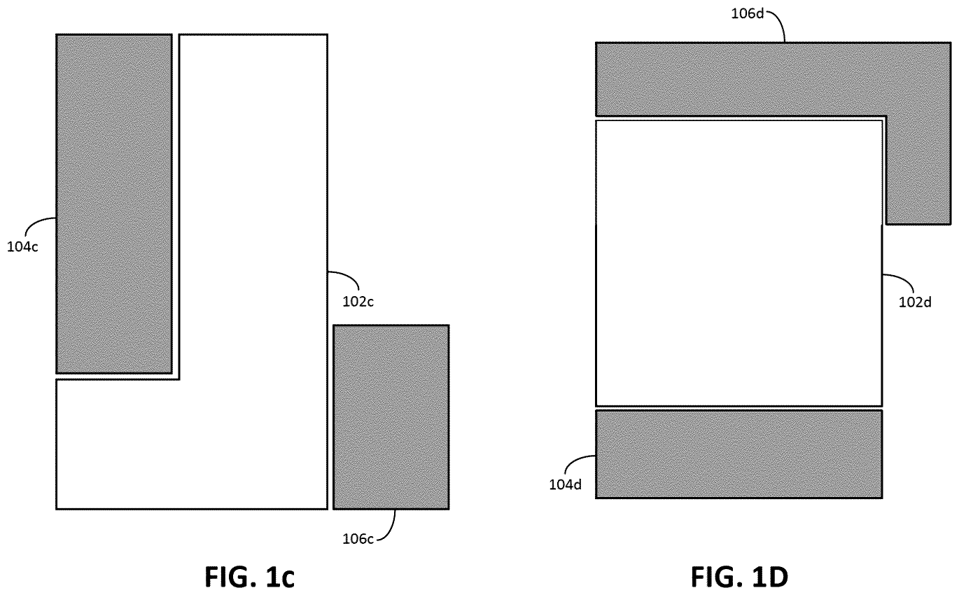

FIG. 1A is a top view of a battery pack 102a and a heat generating component 104a. The battery pack 102a may have a substantially L-shape. The battery pack 102a may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 102a may be configured to provide power to one or more components of a portable electronic device, including the heat generating component 104a. The heat generating component 104a may, by way of example and without limitation, be a processor, radio, system on chip (SoC), or any other component that may generate heat. The heat generating component 104a may malfunction if it exceeds a certain temperature (e.g., overheats). For example, the computing ability of the heat generating component 104a may be adversely affected if it overheats.

FIG. 1B is a top view of a battery pack 102b and a heat generating component 104b. Unlike the battery pack 102a that has a substantially L-shape, the battery pack 102b may have a substantially square or rectangular shape. The battery pack 102b may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 102b may be configured to provide power to one or more components of a portable electronic device, including the heat generating component 104b. The heat generating component 104b may, by way of example and without limitation, be a processor, radio, system on chip (SoC), or any other component that may generate heat. The heat generating component 104b may malfunction if it exceeds a certain temperature (e.g., overheats). For example, the computing ability of the heat generating component 104b may be adversely affected if it overheats.

FIG. 1C is a top view of a battery pack 102c, a first heat generating component 104c, and a second heat generating component 106c. The battery pack 102c may have a substantially L-shape. The battery pack 102c may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 102c may be configured to provide power to a plurality of components of a portable electronic device, including the heat generating component 104c and the heat generating component 106c. The heat generating component 104c and/or the heat generating component 106c may, by way of example and without limitation, be a processor, radio, system on chip (SoC), or any other component that may generate heat. The heat generating component 104c and/or the heat generating component 106c may malfunction if they exceed a certain temperature (e.g., overheats). For example, the computing ability of the heat generating component 104c and/or the heat generating component 106c may be adversely affected if they overheat.

FIG. 1D is a top view of a battery pack 102d, a first heat generating component 104d, and a second heat generating component 106d. Unlike the battery pack 102c that has a substantially L-shape, the battery pack 102d may have a substantially square or rectangular shape. The battery pack 102d may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 102d may be configured to provide power to a plurality of components of a portable electronic device, including the heat generating component 104d and the heat generating component 106d. The heat generating component 104d and/or the heat generating component 106d may, by way of example and without limitation, be a processor, radio, system on chip (SoC), or any other component that may generate heat. The heat generating component 104d and/or the heat generating component 106d may malfunction if they exceed a certain temperature (e.g., overheats). For example, the computing ability of the heat generating component 104d and/or the heat generating component 106d may be adversely affected if they overheat.

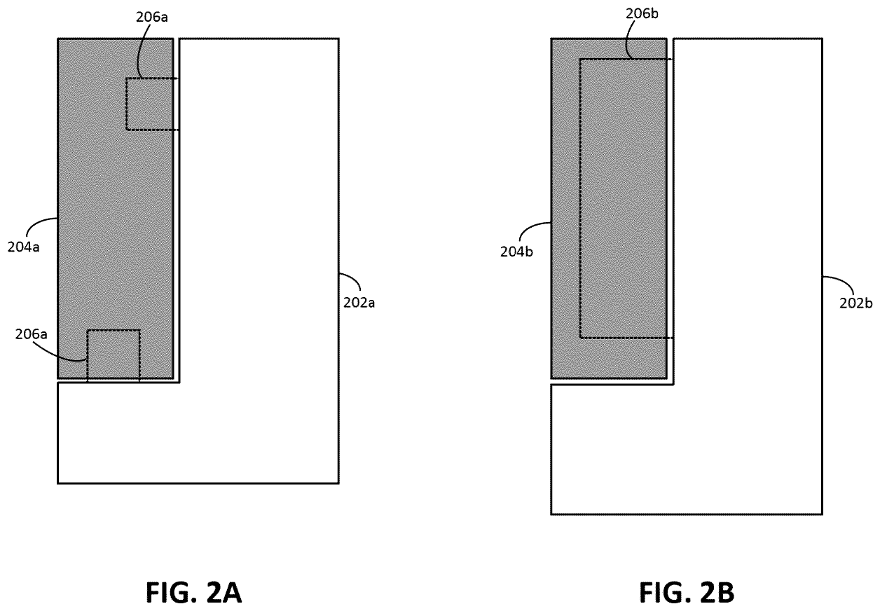

FIG. 2A is a top view of a battery pack 202a and a heat generating component 204a. The battery pack 202a may have a substantially L-shape. The battery pack 202a may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF₆-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 202a may be configured to provide power to one or more components of a portable electronic device, including the heat generating component 204a. The heat generating component 204a may, by way of example and without limitation, be a processor, radio, system on chip (SoC), or any other component that may generate heat. The heat generating component 204a may malfunction if it exceeds a certain temperature (e.g., overheats). For example, the computing ability of the heat generating component 204a may be adversely affected if it overheats.

The battery pack 202a includes a plurality of additional portions 206a extending from the enclosure. The additional portions 206a may, for example, extend from a bottom surface of the enclosure in a direction parallel to the top surface of the enclosure. However, it should be appreciated that the additional portions 206a may extend from any surface or wall of the enclosure in any direction. The additional portions 206a may be configured to capture heat generated by at least one source external to the battery pack 202a, such as heat generated by the heat generating component 204a. The additional portions 206a may provide the battery pack 202a with better coupling to the heat generating component 204a so that the battery pack 202a can more easily capture the heat. While the battery pack 202a shown in FIG. 2A includes two additional portions 206a, it should be appreciated that in other embodiments any number of additional portions may instead be included.

FIG. 2B is a top view of a battery pack 202b and a heat generating component 204b. Unlike the battery pack 202a that has a substantially L-shape, the battery pack 202b may have a substantially square or rectangular shape. The battery pack 202b may include a battery cell and an enclosure enclosing the battery cell. The battery cell may include a plurality of layers. The plurality of layers may include a cathode with an active coating, a separator, and an anode with an active coating. For example, the cathode may be an aluminum foil coated with a lithium compound (e.g., LiCoO₂, LiNCoMn, LiCoAl or LiMn₂O₄) and the anode may be a copper foil coated with carbon or graphite. The separator may include polyethylene (PE), polypropylene (PP), and/or a combination of PE and PP, such as PE/PP or PP/PE/PP. The separator comprises a micro-porous membrane that also provides a “thermal shut down” mechanism. If the battery cell reaches the melting point of these materials, the pores may shut down which prevents ion flow through the membrane.

The plurality of layers may be wound to form a jelly roll structure or can be stacked to form a stacked-cell structure. The plurality of layers may be enclosed within the enclosure and immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The battery pack 202b may be configured to provide power to one or more components of a portable electronic device, including the heat generating component 204b. The heat generating component 204b may, by way of example and without limitation, be a processor, radio, system on chip (SoC), or any other component that may generate heat. The heat generating component 204b may malfunction if it exceeds a certain temperature (e.g., overheats). For example, the computing ability of the heat generating component 204a may be adversely affected if it overheats.

The battery pack 202b includes an additional portion 206b extending from the enclosure. The additional portion 206b may, for example, extend from a bottom surface of the enclosure in a direction parallel to the top surface of the enclosure. However, it should be appreciated that the additional portion 206b may extend from any surface or wall of the enclosure in any direction. The additional portion 206b may be configured to capture heat generated by at least one source external to the battery pack 202b, such as heat generated by the heat generating component 204b. The additional portion 206b may provide the battery pack 202b with better coupling to the heat generating component 204b so that the battery pack 202b can more easily capture the heat. While the battery pack 202b shown in FIG. 2B includes one additional portion 206b, it should be appreciated that in other embodiments any number of additional portions may instead be included.

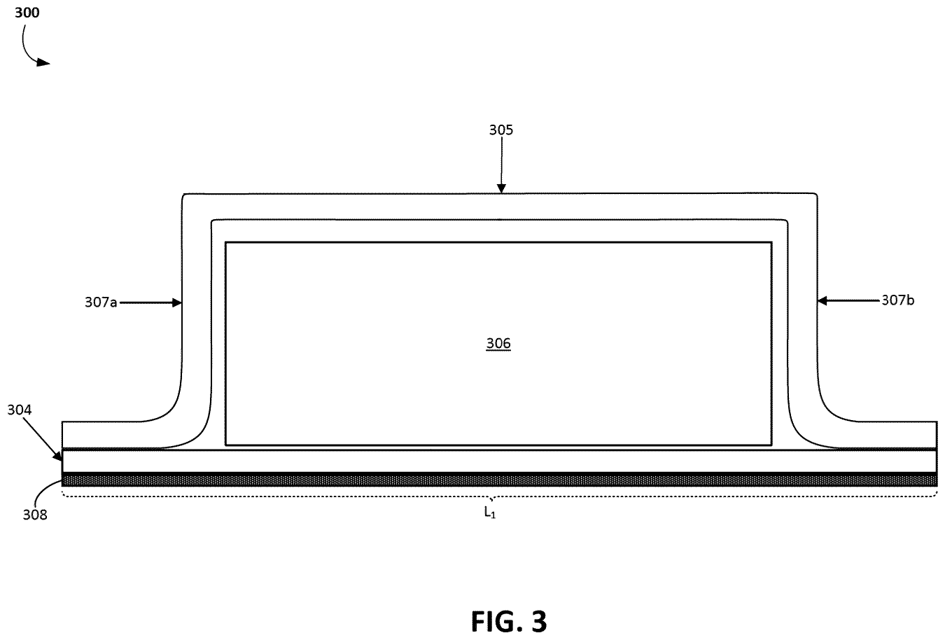

FIG. 3 is a cross sectional view 300 of a battery pack. The battery pack may, for example, be any of the battery packs described above, including battery pack 102a, battery pack 102b, 102c, 102d, 202a, or 202b. The battery pack includes a battery cell 306 and an enclosure 302 enclosing the battery cell 306. As noted above with regard to FIGS. 1A-D and FIGS. 2A-B, the battery cell 306 may include a plurality of layers immersed in an electrolyte. Although not pictured in the example of FIG. 3, it should be appreciated that the battery pack may also include other components, such as a battery management unit, a flex, and one or more adhesives.

In embodiments, the enclosure 302 includes a first portion 305 and a plurality of walls 307a-b that extend perpendicularly or substantially perpendicularly from the first portion 305. For example, the plurality of walls 307a-b may form an angle with the first portion 305 that is within 10% of 90 degrees. The enclosure 302 includes a second portion 304 connected to the plurality of walls 307a-b to form a body enclosing the battery cell 306. For example, the second portion 304 may be welded or clad to the plurality of walls 307a-b to form a body enclosing the battery cell 306. The first portion 305, the second portion 304, and the plurality of walls 307a-b may, in some embodiments, have a thickness substantially between 50 microns and 100 microns.

In embodiments, the first portion 305, the second portion 304, and the plurality of walls 307a-b are a first material. As the first portion 305, the second portion 304, and the plurality of walls 307a-b are exposed to the internals of the battery pack (e.g., exposed to the plurality of layers immersed in an electrolyte), the first material may be a material that is resistant to corrosion by the electrolyte. By way of example and without limitation, the first material may include stainless-steel, nickel-plated steel, or a combination thereof.

In embodiments, the enclosure 302 includes a layer of a second material 308 covering at least a portion of at least one of the first portion 305, the second portion 304, and one of the plurality of walls 307a-b. For example, the layer of the second material 308 may cover an external surface of at least a portion of at least one of the first portion 305, the second portion 304, and one of the plurality of walls 307a-b so that the layer of the second material 308 is not exposed to the internals of the battery pack. The layer of the second material 308 may, in some embodiments, have a thickness substantially between 15 microns and 100 microns.

In embodiments, the layer of the second material 308 is connected to at least a portion of at least one of the first portion 305, the second portion 304, and one of the plurality of walls 307a-b via at least one of an adhesive, a weld, or a clad.

In embodiments, the second material has a greater thermal conductivity than the first material. By way of example and without limitation, the second material may include aluminum, an aluminum alloy, copper, a copper alloy, graphite, graphene, or a combination thereof. As discussed above, the first material may be resistant to corrosion by the electrolyte in which the plurality of layers is immersed. The second material may corrode or have a negative reaction if exposed to the electrolyte. Thus, the first material that is positioned in between the battery cell 306 and the layer of the second material 308 may protect the layer of the second material 308 against corrosion by the electrolyte.

In embodiments, the layer of the second material 308 is configured to capture and diffuse heat across a length Li of the layer of the second material 308. The layer of the second material 308 may capture heat generated by one or more heat generating components external to the battery pack (e.g., heat generating component 104a, heat generating component 104b, heat generating component 104c, heat generating component 106c, heat generating component 104d, heat generating component 106d, heat generating component 204a, and/or heat generating component 204b).

If the battery pack includes at least one additional portion (e.g., additional portions 206a or additional portion 206b) extending from the enclosure, the at least one additional portion may be in contact with one or more of the heat generating components. The at least one additional portion may, for example, extends from the first portion 305 or the second portion 304 in a direction parallel to the first portion 305 or the second portion 304. The at least one additional portion may, through contact, capture the heat generated by such components. The layer of the second material 308 may further capture the heat from the at least one additional portion and diffuse the heat across the length Li of the layer of the second material 308.

In embodiments, the battery pack may capture the heat generated by one or more heat generating components external to the battery pack without being in direct contact with (e.g., without touching) the components. For example, the battery pack may be able to capture the heat generated by one or more heat generating components external to the battery pack by virtue of its proximity to the heat generating components. The heat captured by the battery pack may diffuse towards the layer of the second material 308, which may further capture the heat and diffuse the heat across the length Li of the layer of the second material 308.

By capturing the heat and diffusing the heat across the length Li of the layer of the second material 308, the layer of the second material 308 may facilitate the dissipation the heat generated by the heat-generating components. As a result, the components powered by the battery pack are less likely to overheat—and are therefore less likely to malfunction. Additionally, or alternatively, the heat captured by the layer of the second material 308 may be utilized to warm up the battery cell 306 if a temperature of the battery cell 306 is below a predetermined threshold. As a result, the heat captured by the layer of the second material 308 may be utilized to decrease the charging time of the battery cell 306 in low temperature environments.

In embodiments, the battery pack may be utilized in a portable electronic device that includes additional thermally conductive material external to the battery pack (e.g., a layer along a display of the device or otherwise outside of an enclosure of the battery pack). The additional thermally conductive material may be the same as or different from the second material. For example, the additional thermally conductive material may include aluminum, an aluminum alloy, copper, a copper alloy, graphite, graphene, or a combination thereof. The layer of the second material 308 may be connected to or otherwise form a continuous pathway with the additional thermally conductive material external to the battery pack. Heat generated by one or more heat generating components may be captured by the continuous pathway and diffused across the length of the continuous pathway.

In such embodiments, the layer of the second material 308 and the additional thermally conductive material external to the battery pack may work together to dissipate the heat generated by the heat-generating components. As a result, the components of the portable electronic device are less likely to overheat—and are therefore less likely to malfunction. Additionally, or alternatively, the heat captured by the layer of the second material 308 and the additional thermally conductive material external to the battery pack may be utilized to warm up the battery cell 306 if a temperature of the battery cell 306 is below a predetermined threshold. As a result, the heat captured by the layer of the second material 308 and the additional thermally conductive material external to the battery pack may be utilized to decrease the charging time of the battery cell 306 in low temperature environments.

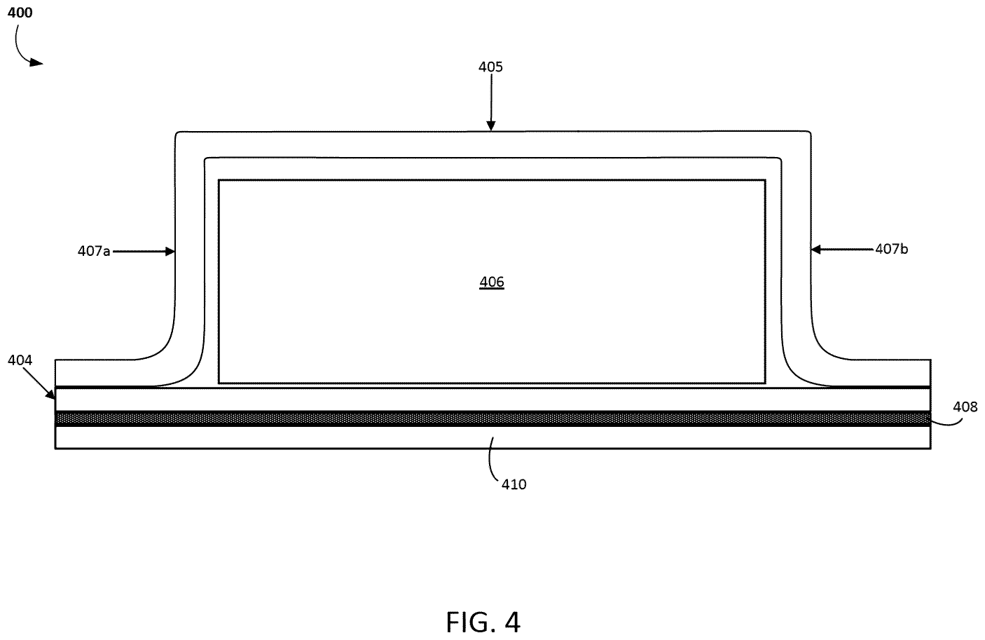

FIG. 4 is a cross sectional view 400 of a battery pack. The battery pack may, for example, be any of the battery packs described above, including battery pack 102a, battery pack 102b, 102c, 102d, 202a, or 202b. The battery pack includes a battery cell 406 and an enclosure 402 enclosing the battery cell 406. As noted above with regard to FIGS. 1A-D and FIGS. 2A-B, the battery cell 406 may include a plurality of layers immersed in an electrolyte. Although not pictured in the example of FIG. 4, it should be appreciated that the battery pack may also include other components, such as a battery management unit, a flex, and one or more adhesives.

In embodiments, the enclosure 402 includes a first portion 405 and a plurality of walls 407a-b that extend perpendicularly or substantially perpendicularly from the first portion 405. For example, the plurality of walls 407a-b may form an angle with the first portion 405 that is within 10% of 90 degrees. The enclosure 402 includes a second portion 404 connected to the plurality of walls 407a-b to form a body enclosing the battery cell 406. For example, the second portion 404 may be welded or clad to the plurality of walls 407a-b to form a body enclosing the battery cell 406. The first portion 405, the second portion 404, and the plurality of walls 407a-b may, in some embodiments, have a thickness substantially between 50 microns and 100 microns.

In embodiments, the first portion 405, the second portion 404, and the plurality of walls 407a-b are a first material. As the first portion 405, the second portion 404, and the plurality of walls 407a-b are exposed to the internals of the battery pack (e.g., exposed to the plurality of layers immersed in an electrolyte), the first material may be a material that is resistant to corrosion by the electrolyte. By way of example and without limitation, the first material may include stainless-steel, nickel-plated steel, or a combination thereof.

In embodiments, the enclosure 402 includes a layer of a second material 408 covering at least a portion of at least one of the first portion 405, the second portion 404, and one of the plurality of walls 407a-b. For example, the layer of the second material 408 may cover an external surface of at least a portion of at least one of the first portion 405, the second portion 404, and one of the plurality of walls 407a-b so that the layer of the second material 408 is not exposed to the internals of the battery pack. The layer of the second material 408 may, in some embodiments, have a thickness substantially between 15 microns and 100 microns

In embodiments, the layer of the second material 408 is connected to at least a portion of at least one of the first portion 405, the second portion 404, and one of the plurality of walls 407a-b via at least one of an adhesive, a weld, or a clad.

In embodiments, the second material has a greater thermal conductivity than the first material. By way of example and without limitation, the second material may include aluminum, an aluminum alloy, copper, a copper alloy, graphite, graphene, or a combination thereof. As discussed above, the first material may be resistant to corrosion by the electrolyte in which the plurality of layers is immersed. The second material may corrode or have a negative reaction if exposed to the electrolyte. Thus, the first material that is positioned in between the battery cell 406 and the layer of the second material 408 may protect the layer of the second material 408 against corrosion by the electrolyte.

In embodiments, the layer of the second material 408 is configured to capture and diffuse heat across a length of the layer of the second material 408. The layer of the second material 408 may capture heat generated by one or more heat generating components external to the battery pack (e.g., heat generating component 104a, heat generating component 104b, heat generating component 104c, heat generating component 106c, heat generating component 104d, heat generating component 106d, heat generating component 204a, and/or heat generating component 204b).

If the battery pack includes at least one additional portion (e.g., additional portions 206a or additional portion 206b) extending from the enclosure, the at least one additional portion may be in contact with one or more of the heat generating components. The at least one additional portion may, for example, extends from the first portion 405 or the second portion 404 in a direction parallel to the first portion 405 or the second portion 404. The at least one additional portion may, through contact, capture the heat generated by such components. The layer of the second material 408 may further capture the heat from the at least one additional portion and diffuse the heat across the length Li of the layer of the second material 408.

In embodiments, the battery pack may capture the heat generated by one or more heat generating components external to the battery pack without being in direct contact with (e.g., without touching) the components. For example, the battery pack may be able to capture the heat generated by one or more heat generating components external to the battery pack by virtue of its proximity to the heat generating components. The heat captured by the battery pack may diffuse towards the layer of the second material 408, which may further capture the heat and diffuse the heat across the length of the layer of the second material 408.

By capturing the heat and diffusing the heat across the length of the layer of the second material 408, the layer of the second material 408 may facilitate the dissipation the heat generated by the heat-generating components. As a result, the components powered by the battery pack are less likely to overheat—and are therefore less likely to malfunction. Additionally, or alternatively, the heat captured by the layer of the second material 408 may be utilized to warm up the battery cell 406 if a temperature of the battery cell 406 is below a predetermined threshold. As a result, the heat captured by the layer of the second material 408 may be utilized to decrease the charging time of the battery cell 406 in low temperature environments.

In embodiments, the battery pack may be utilized in a portable electronic device that includes additional thermally conductive material external to the battery pack (e.g., a layer along a display of the device or otherwise outside of an enclosure of the battery pack). The additional thermally conductive material may be the same as or different from the second material. For example, the additional thermally conductive material may include aluminum, an aluminum alloy, copper, a copper alloy, graphite, graphene, or a combination thereof. The layer of the second material 408 may be connected to or otherwise form a continuous pathway with the additional thermally conductive material external to the battery pack. Heat generated by one or more heat generating components may be captured by the continuous pathway and diffused across the length of the continuous pathway.

In such embodiments, the layer of the second material 408 and the additional thermally conductive material external to the battery pack may work together to dissipate the heat generated by the heat-generating components. As a result, the components of the portable electronic device are less likely to overheat—and are therefore less likely to malfunction. Additionally, or alternatively, the heat captured by the layer of the second material 408 and the additional thermally conductive material external to the battery pack may be utilized to warm up the battery cell 406 if a temperature of the battery cell 406 is below a predetermined threshold. As a result, the heat captured by the layer of the second material 408 and the additional thermally conductive material external to the battery pack may be utilized to decrease the charging time of the battery cell 406 in low temperature environments.

In embodiments, the enclosure includes a layer of the first material 410 covering the layer of the second material 408. As noted above, the first material may be corrosion resistant. By covering the layer of the second material 408 with the layer of the first material 410, the layer of the second material 408 may be protected against corrosion by factors external to the battery pack.

In embodiments, the first material may have a better surface energy than the second material for an adhesive that may be used to secure the battery pack in a portable electronic device. By covering the layer of the second material 408 with the layer of the first material 410, the battery pack may be adhered within the portable electronic device in a more secure manner.

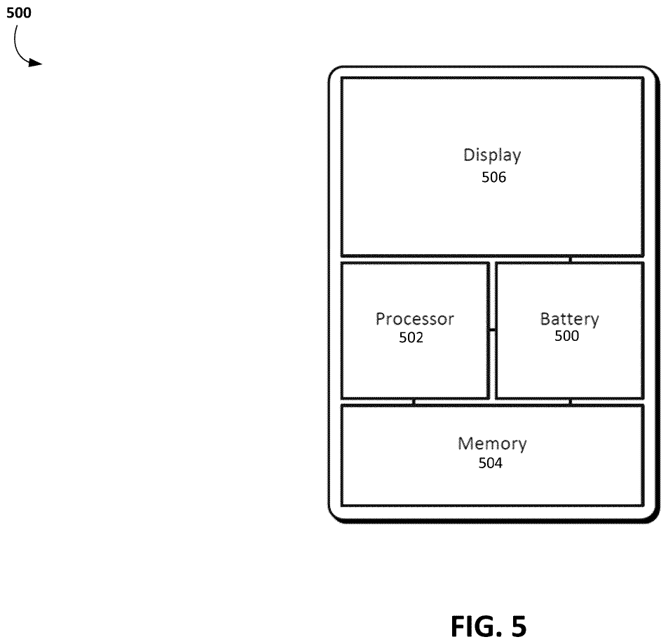

FIG. 5 illustrates a portable electronic device 500, in accordance with various aspects of the subject technology. The battery pack 500 may, for example, be any of the battery packs described above, including battery pack 102a, battery pack 102b, battery pack 102c, battery pack 102d, battery pack 202a, or battery pack 202b. The battery pack 500 can generally be used in any type of electronic device. For example, FIG. 5 illustrates a portable electronic device 500 which includes a processor 502, a memory 504 and a display 506, which are all powered by the battery pack 500. Portable electronic device 500 may correspond to a laptop computer, tablet computer, mobile phone, personal digital assistant (PDA), digital music player, watch, and wearable device, and/or other type of battery-powered electronic device.

Battery pack 500 may include a battery cell (e.g., battery cell 306, battery cell 406) and an enclosure. The enclosure may include a first portion (e.g., first portion 305, first portion 405) and a plurality of walls (e.g., walls 307a-b, walls 407a-b) that extend perpendicularly from the first portion. The enclosure may include a second portion (e.g., second portion 304, second portion 404) connected to the plurality of walls to form a body enclosing the battery cell. The first portion, the second portion, and the plurality of walls may be a first material comprising stainless steel. The enclosure may include a layer of a second material (e.g., layer 308, layer 408) covering at least a portion of at least one of the first portion, the second portion, and one of the plurality of walls. The second material may comprise aluminum, an aluminum alloy, copper, a copper alloy, graphite, graphene, or a combination thereof and may have a greater thermal conductivity than the first material.

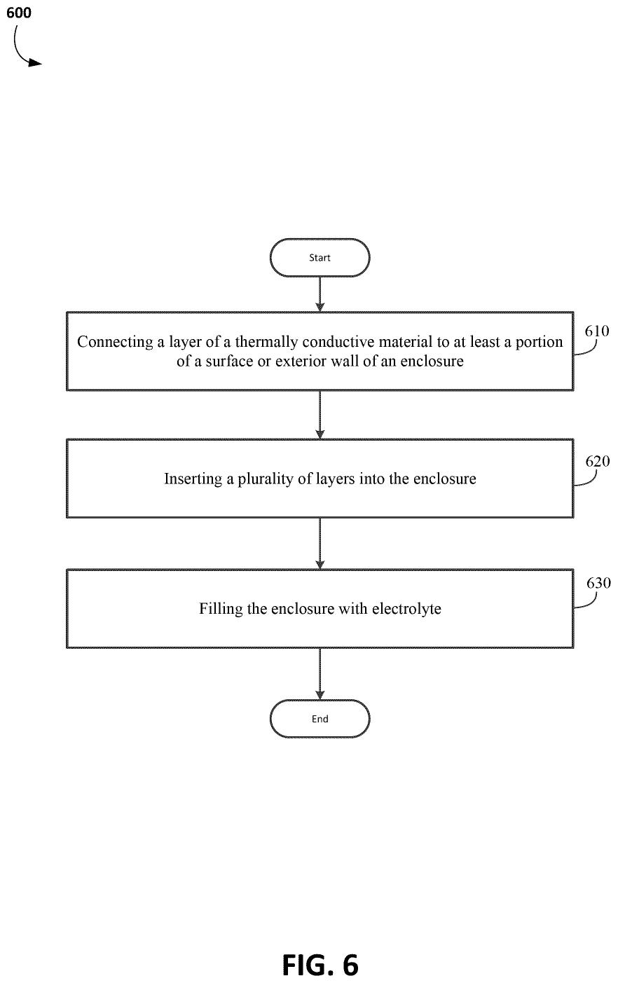

FIG. 6 illustrates an example method 600 for manufacturing a battery pack, such as the battery pack 102a, battery pack 102b, battery pack 102c, battery pack 102d, battery pack 202a, or battery pack 202b, in accordance with various aspects of the subject technology. It should be understood that, for any process discussed herein, there can be additional, fewer, or alternative steps performed in similar or alternative orders, or in parallel, within the scope of the various embodiments unless otherwise stated.

At operation 610, a layer of a thermally conductive material may be connected to at least a portion of a surface or exterior wall of an enclosure. For example, the enclosure may include a first portion (e.g., first portion 305, first portion 405) and a plurality of walls (e.g., walls 307a-b, walls 407a-b) that extend perpendicularly from the first portion. The enclosure may include a second portion (e.g., second portion 304, second portion 404) configured to be connected to the plurality of walls to form a body for enclosing a battery cell. The first portion, the second portion, and the plurality of walls may be a first material comprising stainless steel. The enclosure may include the layer of the thermally conductive material (e.g., layer 308, layer 408) covering at least a portion of at least one of the first portion, the second portion, and one of the plurality of walls. The thermally conductive material may comprise aluminum, an aluminum alloy, copper, a copper alloy, graphite, graphene, or a combination thereof and may have a greater thermal conductivity than the first material.

At operation 620, a plurality of layers is inserted within an enclosure. The plurality of layers may include a plurality of layers comprising a cathode with an active coating, a separator, and an anode with an active coating. The plurality of layers may be wound to form a jelly roll structure or can be stacked to form a stacked-cell structure.

At operation 630, the enclosure may be filled with an electrolyte. For example, the plurality of layers may be immersed in an electrolyte. The first material may be resistant to corrosion by the electrolyte.

The battery packs, battery assemblies, and various non-limiting components and embodiments as described herein can be used with various electronic devices. Such electronic devices can be any electronic devices known in the art. For example, the device can be a telephone, such as a mobile phone, and a land-line phone, or any communication device, such as a smart phone, including, for example an iPhone®, and an electronic email sending/receiving device. The battery cans, battery assemblies, and various non-limiting components and embodiments as described herein can be used in conjunction with a display, such as a digital display, a TV monitor, an electronic-book reader, a portable web-browser (e.g., iPad®), watch and a computer monitor. The device can also be an entertainment device, including a portable DVD player, conventional DVD player, Blue-Ray disk player, video game console, music player, such as a portable music player (e.g., iPod®), etc. Devices include control devices, such as those that control the streaming of images, videos, sounds (e.g., Apple TV®), or a remote control for a separate electronic device. The device can be a part of a computer or its accessories, laptop keyboard, laptop track pad, desktop keyboard, mouse, and speaker.

While the disclosure has been described with reference to various implementations, it will be understood that these implementations are illustrative and that the scope of the disclosure is not limited to them. Many variations, modifications, additions, and improvements are possible. More generally, implementations in accordance with the disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A battery pack comprising:
a battery cell; and
an enclosure comprising:
a first portion and a plurality of walls that extend perpendicularly from the first portion;
a second portion connected to the plurality of walls to form a body enclosing the battery cell, wherein the first portion, the second portion, and the plurality of walls are a first material comprising stainless steel; and
a layer of a second material covering at least a portion of at least one of the first portion, the second portion, and one of the plurality of walls, the second material comprising aluminum, an aluminum alloy, copper, a copper alloy, graphite, graphene, or a combination thereof and having a greater thermal conductivity than the first material.

2. The battery pack of claim 1, wherein the layer of the second material is configured to capture and diffuse heat across a length of the layer of the second material.

3. The battery pack of claim 1, wherein the layer of the second material is connected to the first portion, the second portion, or one of the plurality of walls via at least one of an adhesive, a weld, or a clad.

4. The battery pack of claim 1, wherein the enclosure further comprises a layer of the first material covering the layer of the second material.

5. The battery pack of claim 1, wherein the battery cell comprises a set of layers immersed in an electrolyte, the first material being resistant to corrosion by the electrolyte.

6. The battery pack of claim 1, wherein the enclosure further comprises at least one additional portion that extends from the first portion or the second portion in a direction parallel to the first portion or the second portion, the at least one additional portion configured to capture heat generated by a source external to the battery pack.

7. The battery pack of claim 6, wherein the layer of the second material is configured to further capture the heat from the at least one additional portion and diffuse the heat across a length of the layer of the second material.

8. A portable electronic device, comprising:
a plurality of components powered by a battery pack; and
a device enclosure enclosing the battery pack,
the battery pack comprising:
a battery cell; and
an enclosure comprising:
a first portion and a plurality of walls that extend perpendicularly from the first portion;
a second portion connected to the plurality of walls to form a body enclosing the battery cell, wherein the first portion, the second portion, and the plurality of walls are a first material comprising stainless steel; and
a layer of a second material covering at least a portion of at least one of the first portion, the second portion, and one of the plurality of walls, the second material comprising aluminum, an aluminum alloy, copper, a copper alloy, graphite, graphene, or a combination thereof and having a greater thermal conductivity than the first material.

9. The portable electronic device of claim 8, wherein the layer of the second material is configured to capture and diffuse heat across a length of the layer of the second material.

10. The portable electronic device of claim 9, wherein at least one of the plurality of components generates the heat.

11. The portable electronic device of claim 8, wherein the layer of the second material is connected to the first portion, the second portion, or the plurality of walls via at least one of an adhesive, a weld, or a clad.

12. The portable electronic device of claim 8, wherein the enclosure further comprises a layer of the first material covering the layer of the second material.

13. The portable electronic device of claim 8, wherein the battery cell comprises a set of layers immersed in an electrolyte, the first material being resistant to corrosion by the electrolyte.

14. The portable electronic device of claim 8, wherein the enclosure further comprises at least one additional portion that extends from the first portion or the second portion in a direction parallel to the first portion or the second portion, the at least one additional portion configured to capture heat generated by a source external to the battery pack.

15. The portable electronic device of claim 14, wherein the layer of the second material is configured to further capture the heat from the at least one additional portion and diffuse the heat across a length of the layer of the second material.

16. A battery enclosure comprising:
a first portion and a plurality of walls that extend perpendicularly from the first portion;
a second portion connected to the plurality of walls to form a body enclosing a battery cell, wherein the first portion, the second portion, and the plurality of walls are a first material comprising stainless steel; and
a layer of a second material covering at least a portion of at least one of the first portion, the second portion, and one of the plurality of walls, the second material comprising aluminum, an aluminum alloy, copper, a copper alloy, graphite, graphene, or a combination thereof and having a greater thermal conductivity than the first material.

17. The battery enclosure of claim 16, wherein the layer of the second material is configured to capture and diffuse heat across a length of the layer of the second material.

18. The battery enclosure of claim 16, wherein the layer of the second material is connected to the first portion, the second portion, or the plurality of walls via at least one of an adhesive, a weld, or a clad.

19. The battery enclosure of claim 16, further comprising a layer of the first material covering the layer of the second material.

20. The battery enclosure of claim 16, further comprising:
at least one additional portion that extends from the first portion or the second portion in a direction parallel to the first portion or the second portion, the at least one additional portion configured to capture heat generated by a source external to the battery enclosure,
wherein the layer of the second material is configured to further capture the heat from the at least one additional portion and diffuse the heat across a length of the layer of the second material.
